(19) United States
(12) Patent Application Publication
(10) Pub. No.: US 2009/0236554 A1
(43) Pub. Date: Sep. 24, 2009

(54) KNIFE GATE VALVE WITH SKEWED GATE SEAT INTERFACE

(75) Inventors: Paul Stuart Gifford, Aberdeen, MS (US); Jody William Powell, Amory, MS (US)

Correspondence Address: RATNERPRESTIA, P.O. BOX 980, VALLEY FORGE, PA, 19482, US

(73) Assignee: ITT MANUFACTURING ENTERPRISES, INC., Wilmington, DE (US)

(21) Appl. No.: 12/050,506

(22) Filed: Mar. 18, 2008

(51) Int. Cl. F16K 3/12; F16K 3/314

(52) U.S. Cl. 251/328; 251/326

(57) ABSTRACT

A valve assembly comprising a valve body defining a fluid passage with a seat member positioned adjacent the fluid passage. A gate, having a leading edge, is supported in the valve body and is moveable relative to the fluid passage along a given axis between an open position and a closed positioned wherein the gate sealingly engages the seat member. The seat member includes a portion whose tangent is perpendicular to the given axis. At least a portion of the gate leading edge that is laterally aligned with the portion of the seat member whose tangent is perpendicular to the given axis may extend at an obtuse angle relative to the given axis. The gate leading edge may be configured such that any portion of the leading edge contacting a respective portion of the seat member is non-parallel to a tangent of that portion of the seat member.

### BACKGROUND OF THE INVENTION

This invention relates to valves, more particularly knife gate valves.

Knife gate valves are well known in the art for use in a variety of applications in a broad range of industries, including but not limited to, pulp & paper, chemical, petroleum refining, mining, iron and steel manufacture, waste water, power generation, food and beverage, and marine applications. In particular, knife gate valves are advantageous for use in non-abrasive and abrasive slurry applications and for large diameter water applications. The use of elastomeric valve seats are known to be particularly helpful for applications having high solids or prone to scaling.

One advantage of knife gate valves is the ability to cut through slurries, scale, and surface build ups. Another advantage is the unobstructed flow path, which not only provides high flow capacity, but also allows large objects to safely pass through the valve. Small face-to-face dimensions reduce the weight of the valve and facilitate piping design. Knife gate valves are typically available in sizes as small as 2″ diameter to specially fabricated valves exceeding 100″ in diameter.

Disadvantages of knife gate valves of this type may include pinch of the valve seats between the gate and the valve housing as the gate penetrates the seat. Damage to the seat may also occur if the gate has been tapered to a sharp edge or has burrs or other defects which may catch the seat. Additionally, if the gate has been deflected downstream by the hydrodynamic forces of the flowing media, it may be even more likely to catch on the downstream seat.

### SUMMARY OF THE INVENTION

In one aspect, the present invention provides a valve assembly comprising a valve body defining a fluid passage with a seat member positioned adjacent the fluid passage. A gate, having a leading edge, is supported in the valve body and is moveable relative to the fluid passage along a given axis between an open position and a closed positioned wherein the gate sealingly engages the seat member. The seat member includes a portion whose tangent is perpendicular to the given axis. At least a portion of the gate leading edge that is laterally aligned with the portion of the seat member whose tangent is perpendicular to the given axis extends at an obtuse angle relative to the given axis.

In another aspect, the present invention provides a valve assembly comprising a valve body defining a fluid passage with a seat member positioned adjacent the fluid passage. A gate, having a leading edge, is supported in the valve body and is moveable relative to the fluid passage along a given axis between an open position and a closed positioned wherein the gate sealingly engages the seat member. The gate leading edge is configured such that any portion of the leading edge contacting a respective portion of the seat member is non-parallel to a tangent of that portion of the seat member.

### BRIEF DESCRIPTION OF THE DRAWINGS

FIG. 1A is a plan view of an exemplary valve incorporating an embodiment of the present invention.

FIG. 2 is a cross-sectional view of the valve of FIG. 2, taken across line 2-2 in FIG. 1.

FIG. 3 is an exploded perspective view of the valve of FIG. 1.

FIG. 4 is a perspective view of a leading edge of the gate in accordance with an embodiment of the present invention.

FIG. 5 is a front elevation view of the gate of FIG. 4.

FIG. 6 is a front elevation view of the gate of FIG. 4 relative to an exemplary seat.

FIG. 7 is a perspective view of a leading edge of the gate in accordance with an alternative embodiment of the present invention.

FIG. 8 is a front elevation view of the gate of FIG. 7.

FIG. 9 is a front elevation view of the gate of FIG. 7 relative to an exemplary seat.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

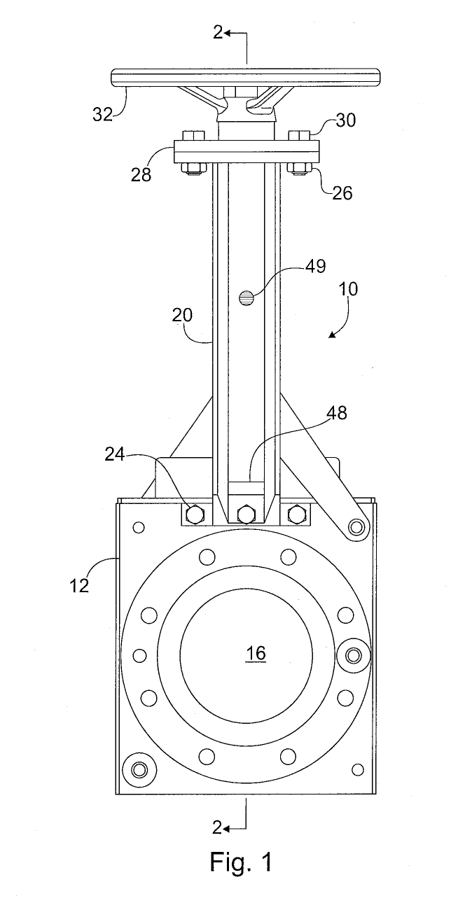

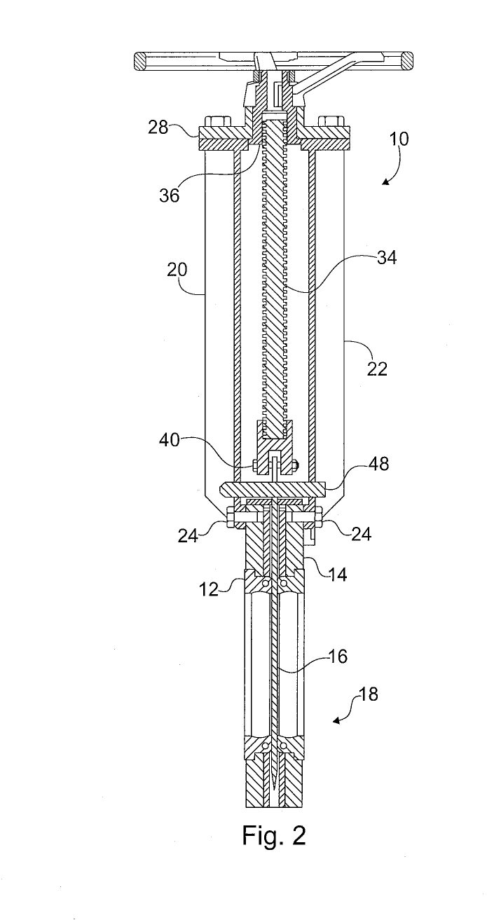

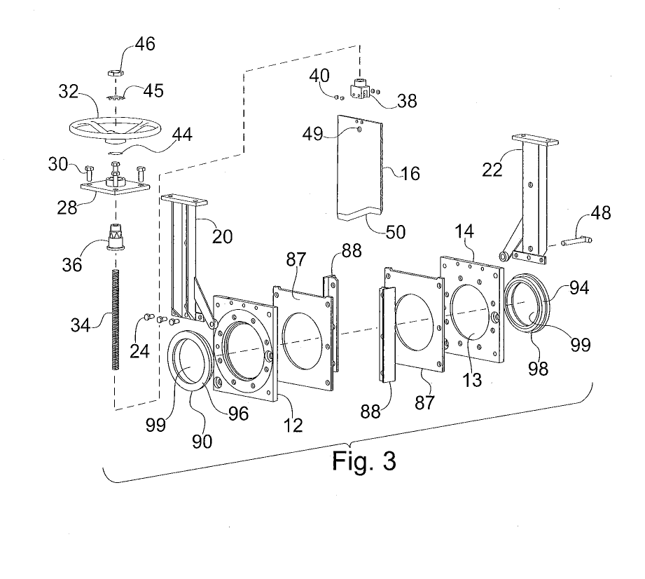

Referring to FIGS. 1-3, an exemplary knife gate valve 10 incorporating an exemplary embodiment of the present invention is shown. The valve 10 described herein is exemplary only and the invention is not limited to such. The valve 10 in accordance with the present invention may have various housing structures, sealing assemblies and actuating assemblies. Accordingly, the invention is not limited to valves having any particular components except those specifically recited in the claims.

Exemplary valve 10 comprises two body halves 12 and 14, and two liners 87. Spacers 88 separate the liners to define a gate channel through which gate 16 slides to open or close pathway 18 through the orifices 13 in the valve body. Mounted on top of the body halves 12 and 14 are yoke halves 20 and 22. The body halves are typically connected to the yoke halves with yoke hold down bolts 24 and fasteners 26. A yoke hub 28, connected to the yoke halves with hub hold down bolts 30 and fasteners 26, sits atop the yoke halves and provides a platform for handwheel 32. The invention is not limited to handwheel actuators, however, as removal of the hub allows the use of other types of actuators, such as but not limited to pneumatic, hydraulic, electric or bevel gear actuators.

Handwheel 32 turns drive nut assembly 36, which turns the threaded stem 34. Wave spring 44, retaining washer 45, and retaining nut 46 fix the drive nut assembly 36 to the handwheel 32. Wave spring 44 keeps the handwheel in tension and prevents it from shaking off in high vibration applications. At the end of stem 34 is gate clamp 38 which is attached to gate 16 with bolts 40. As the threaded stem 34 turns the gate clamp 38 either travels up or down along the axis of the stem 34. A lockout pin 48 is provided for insertion in any of lockout holes 49 in the yoke and/or gate to mechanically prevent the valve from being opened or closed (depending upon the location of the gate when pinned) pursuant to common industry safety procedures. Additional components, not shown or shown but not discussed, may also be present.

Elastomer seats 90 each have an inner face 94 and an outer face 96. Inner face 94 is the face adjacent gate 16 and comprises a substantially flat portion 98. Inner faces 94 are in contact with each other when the gate is removed, thus creating a continuous rubber lining for the media flow-path 90 and with enough compressive force to create a tight seal.

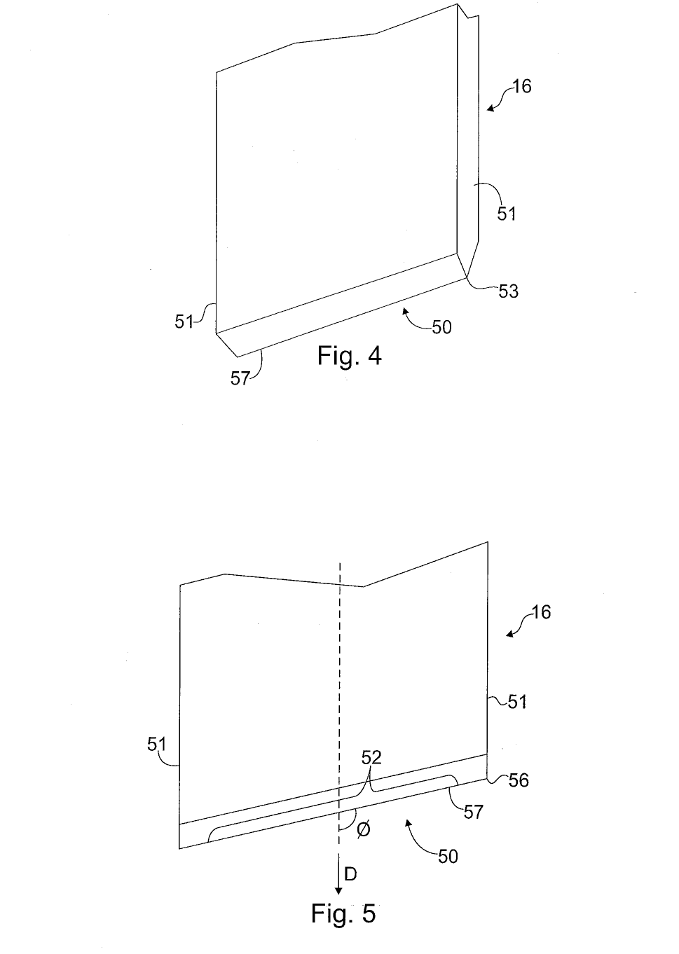

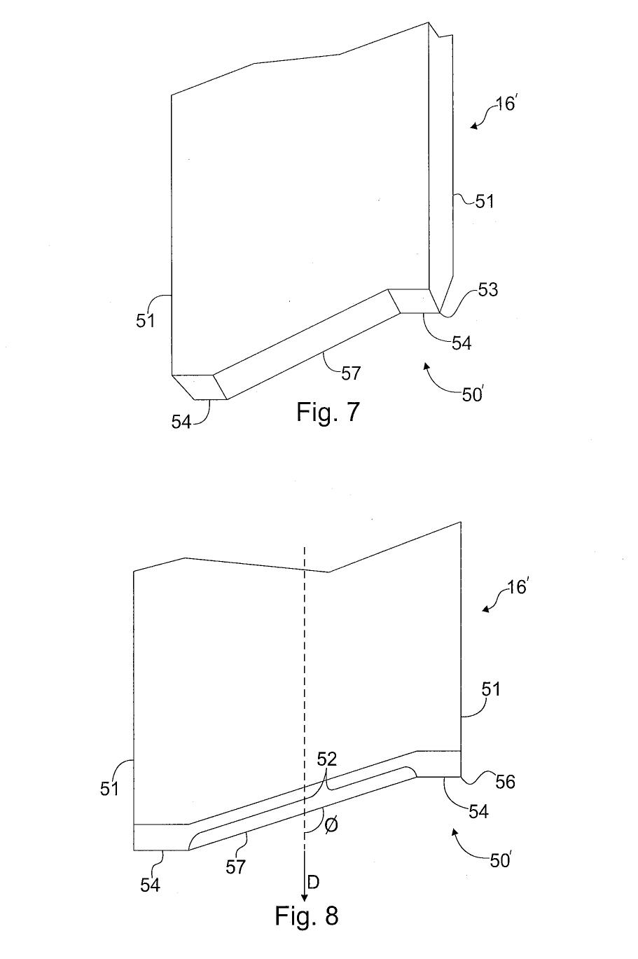

Referring to FIGS. 4-6, a gate 16 in accordance with a first embodiment of the invention will be described. The gate 16 includes a leading edge 50 extending between its opposed sides 51. The leading edge 50 is illustrated with a tapered knife edge 53, but it may have other configurations. As illustrated in FIG. 5, at least a portion 57 of the leading edge 50 extends at an angle Ø relative to the centerline of the gate 16. In the present embodiment, the entire leading edge 50 between the sides defines the angled portion 57, however, the angled portion of the leading edge 50 may extend less than the entire width, as described with respect to the embodiment illustrated in FIGS. 7-9. Angle Ø is desirably in the range of approximately 95 degrees to 135 degrees measured from the centerline toward the trailing side 56 of the leading edge 50. The leading edge 50 may be angled such that the right side defines the trailing side 56 as illustrated, or it may be reversed such that the left side defines the trailing side. The angle Ø is not limited to 95 degrees to 135 degrees, but may be greater or less than such angle. Furthermore, the angle of the leading edge 50 does not have to be consistent as illustrated, but may vary across the width.

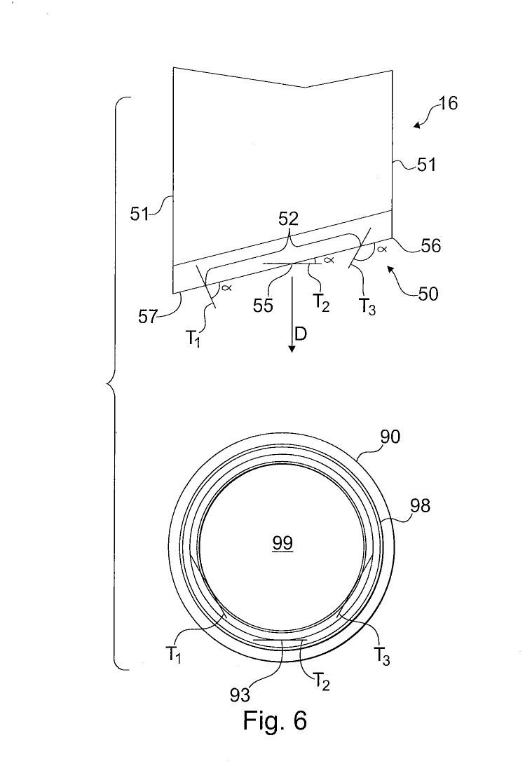

Referring to FIG. 6, it is shown that the tangent T2 to the portion 93 of the seat 90 at the very bottom thereof is perpendicular to the direction of travel D of the gate 16, i.e. parallel to the gate's centerline. This portion 93 of the seat 90 having its tangent T2 perpendicular to the direction of travel D is most prone to pinching. Accordingly, at least the portion 55 of the gate leading edge 50 that is laterally aligned with the portion 93 of the seat member 90 whose tangent is perpendicular to the direction of travel extends at an obtuse angle relative to the centerline.

As further shown in FIG. 6, a portion 52 of the leading edge will contact the seat 90 along the port 99 as the gate 16 is moved toward the closed position. While not as likely, there is also a chance that the seat 90 may be pinched or damaged anywhere along where this portion 52 of the leading edge contacts it. Accordingly, it is desirable that across this portion 52, the leading edge 50 is non-parallel to a tangent of that portion of the seat member 90 which the leading edge will contact. As illustrated in FIG. 6, the leading edge 50 is non-parallel to any of the respective tangents T1, T2, T3 which the leading edge 50 will contact, but instead is at an angle a with respect thereto. This relationship is generally achieved by maintaining the portion 52 at an obtuse angle Ø relative to the centerline, however, other configurations and relationships may be utilized.

In each of these configurations, the gate 16 always presents the leading edge 50 to the point of contact where it penetrates the seat 90 at an angle other than perpendicular to the direction of travel. Because the gate 16 is moving in a direction skewed form the normal to the point of contact, static friction is more quickly overcome between the gate 16 and the seat 90, reducing the likelihood of catching, rolling or pinching the seat 90.

Referring to FIGS. 7-9, a gate 16′ in accordance with another embodiment of the invention will be described. The gate 16′ is similar to the previous embodiment and includes a leading edge 50′ extending between its opposed sides 51. The leading edge 50′ is illustrated with a tapered knife edge 53, but it may have other configurations. As illustrated in FIG. 8, at least a portion 57 of the leading edge 50′ extends at an angle Ø relative to the centerline of the gate 16′. In the present embodiment, the angled portion 57 does not extend completely between the sides 51 of the gate 16′, but instead have portions 54 along each side 51 which extend perpendicular to the centerline of the gate 16′. These portions 54 extend outward of the portion 52 of the leading edge that will contact the seat 90 along the port 99 as the gate 16 is moved toward the closed position. Again, angle Ø is desirably in the range of approximately 95 degrees to 135 degrees measured from the centerline toward the trailing side 56 of the leading edge 50. Since the angled portion 57 does not extend across the entire width of the gate 16′, the leading edge 50′ may have a reduced height compared to the previous embodiment. Again, the leading edge 50′ may be angled such that the right side defines the trailing side 56 as illustrated, or it may be reversed such that the left side defines the trailing side. The angle Ø is not limited to 95 degrees to 135 degrees, but may be greater or less than such angle. Furthermore, the angle of the leading edge 50′ does not have to be consistent as illustrated, but may vary across the width of the angled portion 57.

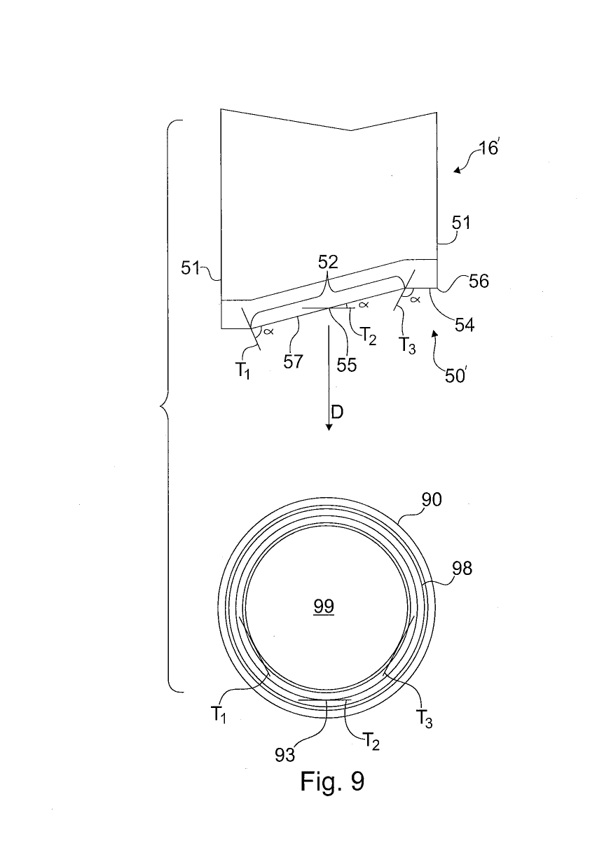

Referring to FIG. 9, it is shown that the tangent T2 to the portion 93 of the seat 90 at the very bottom thereof is perpendicular to the direction of travel D of the gate 16, i.e. parallel to the gate's centerline. This portion 93 of the seat 90 having its tangent T2 perpendicular to the direction of travel D is most prone to pinching. Accordingly, at least the portion 55 of the gate leading edge 50′ that is laterally aligned with the portion 93 of the seat member 90 whose tangent is perpendicular to the direction of travel extends at an obtuse angle Ø relative to the centerline.

As further shown in FIG. 9, a portion 52 of the leading edge 50″ will contact the seat 90 along the port 99 as the gate 16 is moved toward the closed position. It is desirable that across this portion 52, the leading edge 50′ is non-parallel to a tangent of that portion of the seat member 90 which the leading edge will contact. As illustrated in FIG. 9, the leading edge 50′ is non-parallel to any of the respective tangents T1, T2, T3 which the leading edge 50′ will contact, but instead is at an angle α with respect thereto. This relationship is generally achieved by maintaining the portion 52 at an obtuse angle Ø relative to the centerline, however, other configurations and relationships may be utilized.

In each of these configurations, the gate 16′ always presents the leading edge 50′ to the point of contact where it penetrates the seat 90 at an angle other than perpendicular to the direction of travel. Because the gate 16′ is moving in a direction skewed form the normal to the point of contact, static friction is more quickly overcome between the gate 16′ and the seat 90, reducing the likelihood of catching, rolling or pinching the seat 90. The portions 54 do not contact the seat 90 along the port 90, but instead generally remain in continuous contact with the seat member 90 and are not prone to pinching and the like.

Although shown in two embodiments that include a plurality of desirable features, embodiments comprising fewer than all of these features may also be constructed, including any combination of the elements described herein. Accordingly, the invention is not limited only to the embodiment shown. Although ideal for use in slurry service, it should be understood that valves having the features described and claimed herein may be used in any kind of fluid handling service, where the term “fluid” is interpreted broadly, to include gas, liquid, solids, or any combination thereof.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. A valve assembly comprising:
a valve body defining a fluid passage;
a seat member positioned adjacent the fluid passage; and
a gate, having a leading edge, supported in the valve body and moveable relative to the fluid passage along a given axis between an open position and a closed positioned wherein the gate sealingly engages the seat member,
wherein the seat member includes a portion whose tangent is perpendicular to the given axis, and wherein at least a portion of the gate leading edge that is laterally aligned with the portion of the seat member whose tangent is perpendicular to the given axis extends at an obtuse angle relative to the given axis.

2. The valve assembly according to claim 1 wherein the gate has a width and the angled portion of the gate leading edge extends across the width.

3. The valve assembly according to claim 1 wherein the gate has a width and the angled portion of the gate leading edge extends across less than the width.

4. The valve assembly according to claim 3 wherein the gate has opposed sides and a portion of the leading edge adjacent each side extends perpendicular to the given axis.

5. The valve assembly according to claim 1 wherein the obtuse angle is between approximately 95 degrees and 135 degrees.

6. The valve assembly according to claim 1 wherein the leading edge is presented to the point of contact where it penetrates the seat member at an angle other than perpendicular to the given axis.

7. The valve assembly according to claim 1 wherein the gate leading edge is configured such that any portion of the leading edge contacting a respective portion of the seat member is non-parallel to a tangent of that portion of the seat member.

8. A valve assembly comprising:
a valve body defining a fluid passage;
a seat member positioned adjacent the fluid passage; and
a gate, having a leading edge, supported in the valve body and moveable relative to the fluid passage along a given axis between an open position and a closed positioned wherein the gate sealingly engages the seat member,
wherein the gate leading edge is configured such that any portion of the leading edge contacting a respective portion of the seat member is non-parallel to a tangent of that portion of the seat member.

9. The valve assembly according to claim 8 wherein at least a portion of the gate leading edge extends at an obtuse angle relative to the given axis.

10. The valve assembly according to claim 9 wherein the gate has a width and the angled portion of the gate leading edge extends across the width.

11. The valve assembly according to claim 9 wherein the gate has a width and the angled portion of the gate leading edge extends across less than the width.

12. The valve assembly according to claim 11 wherein the gate has opposed sides and a portion of the leading edge adjacent each side extends perpendicular to the given axis.

13. The valve assembly according to claim 9 wherein the obtuse angle is between approximately 95 degrees and 135 degrees.

14. The valve assembly according to claim 8 wherein the leading edge is presented to the point of contact where it penetrates the seat member at an angle other than perpendicular to the given axis.

15. A valve assembly comprising:
a valve body defining a fluid passage;
a seat member positioned adjacent the fluid passage; and
a gate, having a leading edge, supported in the valve body and moveable relative to the fluid passage along a given axis between an open position and a closed positioned wherein the gate sealingly engages the seat member,
wherein the gate leading edge is presented to the point of contact where it penetrates the seat member at an angle other than perpendicular to the given axis.

16. The valve assembly according to claim 15 wherein at least a portion of the gate leading edge extends at an obtuse angle relative to the given axis.

17. The valve assembly according to claim 16 wherein the gate has a width and the angled portion of the gate leading edge extends across the width.

18. The valve assembly according to claim 16 wherein the gate has a width and the angled portion of the gate leading edge extends across less than the width.

19. The valve assembly according to claim 18 wherein the gate has opposed sides and a portion of the leading edge adjacent each side extends perpendicular to the given axis.

20. The valve assembly according to claim 16 wherein the obtuse angle is between approximately 95 degrees and 135 degrees.
